(19) United States
(12) Patent Application Publication
(10) Pub. No.: US 2009/0184060 A1
(43) Pub. Date: Jul. 23, 2009

(54) System and Process for Forming Micro Bubbles in Liquid

(75) Inventor: Dennis L. Mast, Apex, NC (US)

Correspondence Address: COATS & BENNETT, PLLC, 1400 Crescent Green, Suite 300, Cary, NC, 27518, US

(73) Assignee: CLEAN POWER SOLUTIONS, INC., Raleigh, NC (US)

(21) Appl. No.: 12/015,868

(22) Filed: Jan. 17, 2008

(51) Int. Cl. C02F 1/68; C10J 1/08; B01F 3/04

(52) U.S. Cl. 210/749; 261/109; 261/119.1

(57) ABSTRACT

A device for dissolving a gas in a liquid. The device comprises a pressure vessel or column for receiving a gas-entrained liquid via an inlet and for injecting the gas-entrained liquid via a riser into a headspace of the vessel. A flow director is disposed in an upper portion of the vessel or column to form a swirling flow path extending into a liquid pool in a lower portion of the vessel or column. An outlet is provided to direct the liquid away from the vessel or column.

### FIELD OF THE INVENTION

The present invention relates to aeration of liquid systems.

### BACKGROUND

Aeration of liquids is important in many process applications. In waste water treatment for example, various processes require effective aeration to perform efficiently. Typically, blower/diffuser systems are employed. Such systems operate at low efficiencies, and thus require air to be supplied in great excess to produce adequate aeration. There is a need for a system and process to more efficiently provide aeration to liquid systems.

### SUMMARY OF THE INVENTION

The present invention relates to a device for dissolving a gas in a liquid. The device includes a pressure vessel having an inlet disposed on the pressure vessel for receiving a gas-liquid mixture. A riser is disposed in the pressure vessel and connected to the inlet. The riser extends into a head space of the pressure vessel. The riser is adapted to receive the gas-liquid mixture from the inlet and inject the mixture into the head space. An opening is disposed in an upper end of the riser below an interior surface of the pressure vessel. Disposed in an upper portion of the pressure vessel is a flow director that forms a swirling flow path. An outlet is disposed on the pressure vessel for directing the liquid from the pressure vessel.

The present invention provides a method of dissolving a gas into a liquid. The method includes mixing a gas into the liquid to form a gas-liquid mixture. The method also includes directing the mixture into a pressure vessel and into a vessel riser extending within the pressure vessel. In addition, the method includes discharging the mixture under pressure into the pressure vessel and directing the mixture along a swirling flow path and towards an outlet. The method also includes discharging the liquid under pressure from the pressure vessel. The method may further include discharging pressurized liquid with gas dissolved therein into a tank containing a liquid and forming micro bubbles in the tank.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic of an embodiment of the system for producing micro bubbles in a liquid held in a tank.

FIG. 2 is a cross-sectional view of one embodiment of the pressure column of the present invention.

FIG. 3 is a cross-sectional view of a second embodiment of the pressure column of the present invention.

FIG. 4 is a cross-sectional view of a third embodiment of the pressure column of the present invention.

### DETAILED DESCRIPTION

With particular reference to the drawings, a micro bubble forming system, indicated generally by the numeral 100, is provided. Micro bubble forming system 100 includes a liquid source contained in a tank 40. Connected to an outlet 46 of tank 40 is a pump 10. Pump 10 is connected to a venturi device 20 to cause liquid from tank 40 to flow therethrough. Venturi device 20 includes an air inlet 22 to entrain a gas, such as air, into the liquid flow. To direct the flow of gas-entrained liquid from venturi device 20, the venturi device is connected to inlet 32 of a pressure column, indicated generally by the numeral 30. Outlet 34 of pressure column 30 is connected to inlet 42 of tank 40 to return the flow of liquid to the tank. It is appreciated that system 100 provides a generally closed circuit in which liquid may flow from tank 40 and be returned to the tank. In circuit, the liquid passes through venturi 20 where a gas is entrained with the liquid, transits pressure column 30 where the liquid becomes highly saturated with the gas, and returns to tank 40 where micro bubbles are formed. System 100 has utility in such areas as aerating waste water prior to treatment and enriching other fluids with oxygen.

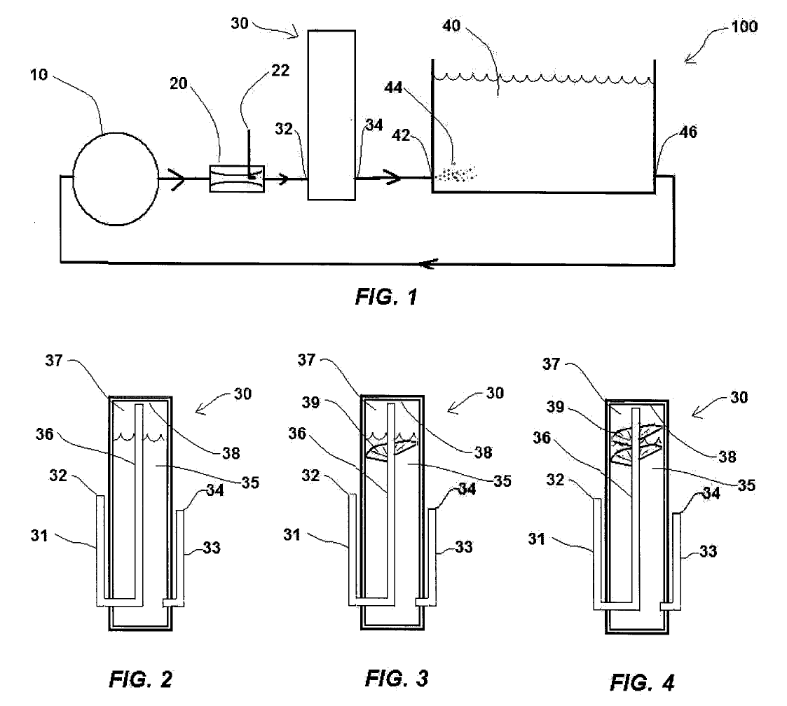

It is appreciated that micro bubble forming system 100 may, in an operable state, include any of various liquid sources. As illustrated in FIG. 1, the liquid source contained in tank 40, and the tank holds a volume of liquid from which liquid is withdrawn, pumped through venturi device 20 and pressure column 30, and returned to the tank. Alternatively, for example, the liquid source may be contained in a pipe through which a liquid is conducted under influence of a separate motive force. A portion of the liquid flowing in the pipe may be withdrawn by means of a first tap or side outlet, pumped through venture device 20 and pressure column 30, and returned to the pipe at a second tap or side inlet.

Turning now to a detailed description of pressure column 30, and referring particularly to FIG. 2, the pressure column comprises generally a pressure vessel capable of withstanding operating pressures. Pressure column or vessel 30 includes a riser 36 that is fluidly connected to inlet 32. Vessel riser 36 extends upward within pressure column 30 and has an opening disposed near an inner surface 38 of the top of the vessel. In one embodiment riser 36 extends to a height such that the upper open end is disposed a short distance down from the inner surface 38 of the top of the vessel forming a gap there between. An open upper end of riser 36 forms the opening, which faces inner surface 38 across the gap. The gap is generally about one inch or smaller.

Inlet 32 to pressure column 30 is disposed at the top of inlet riser 31, and outlet 34 is disposed at the top of outlet riser 33. Generally, inlet riser 31 extends upwardly to about 50% of the height of vessel riser 36 while outlet riser 33 extends upwardly to about 40% of the height of the vessel riser.

In a second embodiment, pressure column 30 includes a helical baffle 39 disposed in an upper portion of the pressure vessel at least partially below head space 37 near the surface of liquid pool 35. See FIG. 3. Helical baffle 39 comprises about one revolution or more of a helical or screw flight and forms a helical flow path in an upper portion of liquid pool 35. In a third embodiment, illustrated in FIG. 4, one or more revolutions of helical baffle 39 are disposed at least partially in head space 37, and one or more revolutions are disposed at least partially in liquid pool 35. Baffle 39 serves as a flow director to encourage a swirling and generally downward flow within pressure column 30.

Micro bubble forming system 100 functions as follows. The liquid is pumped through venturi device 20 where a gas is entrained. As illustrated in FIG. 1, environmental air may be entrained via venturi device 20. However, a gas, such as oxygen, from a gas source or generator may be entrained alternatively or in addition to environmental air. A gas-liquid mixture is formed in venturi device 20 and directed to inlet 32 of pressure column 30 as a gas-entrained liquid flow. In response to the pump driving force, the gas-liquid mixture is directed up vessel riser 36 and injected under pressure into head space 37. In one embodiment, the mixture is ejected under pressure from an opening in riser 36 against interior surface 38. The ejection of the mixture against surface 38 tends to spray the mixture into head space 37. The gas-liquid mixture is incorporated into liquid pool 35 such that the gas becomes dissolved in the liquid at a highly saturated level.

In one embodiment, the apparatus for which is illustrated in FIG. 2, the gas-liquid mixture sprayed into head space 37 descends into liquid pool 35 where the gas dissolves in the liquid. In one embodiment, apparatus illustrated in FIG. 3, a swirling and generally downward movement of the mixture and the liquid in pool 35 is encouraged by helical baffle 36 disposed in an upper portion of liquid pool 35. In one embodiment, apparatus shown in FIG. 4, the gas-liquid mixture descends along helical baffle 38 that is disposed at least partially in head space 37 and at least partially in liquid pool 35. A swirling and generally downward movement of gas and liquid in pressure column 30 at least partially facilitates the gas becoming dissolved in the liquid.

Sufficient pressure is maintained in pressure column 30 further encourage dissolution of the gas and to force liquid with gas dissolved therein from pool 35 through outlet 34 and thence to tank 40. Generally, the pressure within head space 37 ranges from about 35 psi to about 60 psi. Due to the pressure drop between liquid leaving pressure column 30 and liquid in tank 40, gas will come out of solution and form micro bubbles 44 as the liquid returns to the tank. The pressure drop preferably ranges between about 8 psi and about 10 psi. Micro bubbles formed range in diameter from about 1 micron to about 10 microns and generally less than about 5 microns. Continued operation of system 100 for a sufficient time results in a cloudy or milky appearance of the liquid in tank 40. This cloudiness evidences extensive dispersion of micro bubbles throughout the liquid.

By way of example two functional scale models are described here below. In both cases, the liquid is water and the gas is environmental air. These scale models illustrate the utility of system 100 in aerating water.

Model I includes tank 40 holding 55 gallons of water. Pressure column 30 is 46½″ high formed from 8⅝″ OD×¼″ wall thickness steel tube capped on each end by a 1″ steel plate welded there to and having a capacity of 10 gallons. Risers 31, 33, and 36 are formed from ¾″ schedule 40S steel pipe. The gap between the upper end of riser 36 and surface 38 is 1″. Venturi device 20 is a Mazzei® Injector Model NK PVDF 784 (Mazzei Injector Corp. 500 Rooster Dr. Bakersfield, Calif. 93307). A 1 hp pump 30 is used and a flow rate of 10 gpm is maintained through venturi device 20.

Model II includes tank 40 holding 5 gallons of water. Pressure column 30 is 18″ high formed from 2½″ OD×¼″ wall thickness steel tube capped on each end by a 3/16″ steel plate welded there to and having a capacity of 0.24 gallons. Risers 31, 33, and 36 are formed from ¼″ schedule 80S steel pipe. The gap between the upper end of riser 36 and surface 38 is ⅜″. Venturi device 20 is a Mazzei® Injector Model NK PVDF 287. A ¼ hp pump 30 is used and a flow rate of 1 gpm is maintained through venturi device 20.

The responses of the two models are summarized in Table I.

TABLE I

| Model | Time to Cloud |
|---|---|
| I | 4 minutes |
| II | 2 minutes |

A utility of the present invention is to enhance, for example, oxygen-requiring reactions in a reservoir such as tank 40. Tank 40 may be a water treatment tank, for example, where aerobic degradation of pollutants is desired. The distribution of micro bubbles of air, for example, in such a treatment tank may enhance and accelerate the removal of such pollutants. The enhancement may result in a reduction in treatment time and/or tank size.

The present invention may, of course, be carried out in other specific ways than those herein set forth without departing from the scope and the essential characteristics of the invention. The present embodiments are therefore to be construed in all aspects as illustrative and not restrictive.

1. A device for dissolving a gas in a liquid, comprising
a. a pressure vessel;
b. an inlet disposed on the pressure vessel for receiving a gas-liquid mixture;
c. a vessel riser disposed in the pressure vessel and connected to the inlet and extending into a head space of the pressure vessel, the riser receiving the gas-liquid mixture from the inlet and injecting the gas-liquid mixture into the head space;
d. an opening in an upper end of the vessel riser below an interior surface of the pressure vessel;
e. a flow director disposed in an upper portion of the pressure vessel and forming a swirling flow path for directing the gas-liquid mixture downwardly along the swirling flow path; and
f. an outlet disposed on the pressure vessel for directing the liquid from the pressure vessel.

2. The device of claim 1 wherein the pressure vessel forms an elongated vertical column.

3. The device of claim 1 wherein the opening in the vessel riser is disposed on an end of the riser and faces an interior surface of the pressure vessel.

4. The device of claim 3 wherein a gap between the end of the vessel riser and the interior surface of the pressure vessel is approximately 1 inch or less.

5. The device of claim 1 wherein the flow director includes a helical baffle having one or more revolutions.

6. The device of claim 1 wherein the flow director is disposed near a surface of a liquid pool in the pressure vessel.

7. The device of claim 1 wherein the flow director is at least partially disposed above a surface of a liquid pool in the pressure vessel.

8. The device of claim 1 wherein the flow director is at least partially disposed within a liquid pool in the pressure vessel.

9. The device of claim 1 wherein the inlet includes an inlet riser having a first height and connecting the inlet to the vessel riser, and the outlet includes an outlet riser having a second height connecting the outlet to the pressure vessel.

10. The device of claim 9 wherein the vessel riser has a vessel riser height and wherein the first height is about 50 percent of the vessel riser height and the second height is about 40% of the vessel riser height.

11. A method of dissolving a gas into a liquid, including:
a. mixing a gas into the liquid to form a gas-liquid mixture;
b. directing the mixture into a pressure vessel and into a vessel riser extending within the pressure vessel;
c. discharging the mixture under pressure into the pressure vessel;
d. directing the mixture along a swirling flow path and towards an outlet; and
e. discharging the liquid under pressure from the pressure vessel.

12. The method of claim 11 wherein mixing the gas in the liquid includes flowing the liquid through a venturi and admitting the gas into the venturi to entrain the gas in the flowing liquid.

13. The method of claim 11 wherein directing the gas-liquid mixture into the pressure vessel includes forcing the mixture through an inlet at an upper end of an inlet riser and through the inlet riser into the vessel riser.

14. The method of claim 11 wherein discharging the gas-liquid mixture under pressure into the pressure vessel includes injecting the mixture into a head space of the vessel.

15. The method of claim 14 wherein injecting the mixture into the head space of the vessel includes directing the mixture from an opening of the vessel riser towards an inner surface of the pressure vessel.

16. The method of claim 11 wherein directing the gas-liquid mixture along a swirling flow path includes flowing the mixture along a helical baffle disposed in an upper portion of the pressure vessel.

17. The method of claim 11 wherein directing the gas-liquid mixture along a swirling flow path includes flowing the mixture along a helical baffle disposed at least partially in a head space of the vessel and at least partially in a liquid pool in the vessel.

18. The method of claim 11 including maintaining a pressure in a head space of the vessel.

19. The method of claim 18 wherein the pressure in the head space is in a range extending from approximately 35 psi to approximately 65 psi.

20. The method of claim 11 including directing the liquid from the pressure vessel into an inlet disposed in a liquid-containing tank where the pressure adjacent the inlet in the tank is lower than the pressure of the liquid directed from the pressure vessel, the difference in pressures forming a pressure drop.

21. The method of claim 20 including forming gas bubbles in the tank.

22. The method of claim 20 wherein liquid contained in the tank forms a cloudy appearance.

23. The method of claim 20 wherein the pressure drop is in a range extending from approximately 8 psi to approximately 10 psi.
